(19) United States
(12) Patent Application Publication
(10) Pub. No.: US 2009/0313171 A1
(43) Pub. Date: Dec. 17, 2009

(54) ELECTRONIC TRANSACTION VERIFICATION

(75) Inventor: Yacov Yacobi, Mercer Island, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/140,288

(22) Filed: Jun. 17, 2008

(51) Int. Cl. H04L 9/00; H04L 9/06; H04L 9/08

(52) U.S. Cl. 705/51; 713/176; 380/277

(57) ABSTRACT

Product registration of an electronic good (e.g., software) over the telephone is made easier by reducing the length of code that is communicated to the electronic good provider (e.g., software provider). More particularly, an electronic goods provider provides a product ID comprising a message and digital signature to a client purchasing their electronic good. The electronic good is registered over a telephone by providing only the digital signature portion of a product ID to a telephone registration server having the electronic good provider's private key. The telephone registration server computes a message from the digital signature and private key. If the message has an expected structure (e.g., zeros in certain places) the software is authentic. Therefore, the verification method ensures software authenticity using only a portion of the product ID and thereby reducing the amount of information that needs to be transferred over the telephone to perform the registration process.

### BACKGROUND

An increasingly large number of products are being provided to clients in digital form. Products in a digital form (e.g., software products and the like, music, video, books, etc.) are often distributed to clients via fixed computer readable media, such as, for example, compact disc (CD-ROM), digital versatile disc (DVD-ROM), soft magnetic diskette, or hard magnetic disk (e.g., a preloaded hard drive). More recently, clients have been able to download digital content directly from developers or service providers to their digital devices using data communication services, such as those associated with communication networks, such as intranets and extranets.

Unfortunately, due to its nature digital content has a number of security shortcomings that allow widespread digital piracy (e.g., unauthorized reproduction or use of a copyrighted digital media). For example, digital content can be easily duplicated or accessed by unauthorized parties. Every year digital piracy results in billions of dollars of lost revenue for digital media development companies and providers. Therefore, many such companies invest significant resources into digital rights management (DRM) protection to prevent unauthorized distribution, copying, and/or illegal operation of, or access to digital content.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Product registration of an electronic good (e.g., software) over the telephone is made easier by reducing the length of a product identification code (product ID) that is communicated to the electronic good's provider (e.g., software provider). More particularly, an electronic good is registered over a telephone by providing a reduced portion of its product ID to a telephone registration server which uses a bi-linear pairing signature system to verify the authenticity of the electronic good.

Essentially, an electronic good provider provides a product ID to a client purchasing an electronic good. The product ID comprises a message and a digital signature, wherein the digital signature is a hash value of the message encrypted with the electronic good provider's private key. The client performs a verification via a telephone to ensure that the client is not using a pirated (e.g., unauthorized) copy of a copyrighted software program. The verification requires that the client provide the digital signature portion of the product ID (e.g., the first 10 characters of a 25 characters long product ID) to a trusted verifier (e.g., telephone registration server) that has the electronic good provider's private key. The trusted verifier uses the electronic good provider's private key to reconstruct the message. The trusted verifier then compares the reconstructed message to an expected structure to ensure that the client is not using a pirated (e.g., unauthorized copy of a copyrighted software program) version of the electronic good. If the expected structure is found, the electronic good is authentic and the trusted verifier (e.g., telephone registration server) then returns a registration code which activates the client's software. Verification using only the digital signature portion of the product ID reduces the amount of information that needs to be transferred over the telephone line to perform electronic good registration.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a block diagram illustrating a high level block diagram of a method of electronic product identification.

FIG. 2 is a flow chart illustrating an exemplary method of utilizing a bi-linear pairing signature system for telephone registration.

FIG. 3 illustrates a communication diagram showing the transfer of data as provided herein.

FIG. 4 is a flow chart illustrating a detailed exemplary method of utilizing a bi-linear pairing signature system for telephone registration.

FIG. 5 is a flow chart illustrating an exemplary method of performing a first verification method (verification I).

FIG. 6 is a flow chart illustrating an exemplary method of performing a second verification method (verification II).

FIG. 7 shows a system configured to perform the first and second verification methods.

FIG. 8 shows a system of three independent registration servers configured to perform secret sharing of a software provider's private key.

FIG. 9 shows a system of n independent registration servers configured to perform secret sharing of a software provider's private key additionally using a threshold scheme.

FIG. 10 is an illustration of an exemplary computer-readable medium comprising processor-executable instructions configured to embody one or more of the provisions set forth herein.

FIG. 11 illustrates an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

Various DRM techniques have been developed and employed in an attempt to stop digital piracy. One technique requires clients to register digital goods with the digital good's developer or provider. For example, many software programs come with a product identification code (product ID) (e.g., a string of alpha numeric characters) that users provide to the software provider either through mail, over a telephone, or online via the Internet or a direct connection for proper software performance. In this technique, digital goods require the client to enter a registration code before allowing the digital good to be fully operational or the digital content to be fully accessed. As computers get faster and the ability to break cryptographic codes increases, the length of product IDs continues to grow to provide increased security against piracy. Longer codes are especially cumbersome for product users not connected to the Internet who register via the telephone. Therefore, there is a need for a method of product register via a telephone with a reduced length product ID.

The present techniques and systems, provided herein, relate to a method by which product registration of an electronic good (e.g., software) over a telephone is made easier by reducing the length of a product identification code (product ID) that is communicated to the electronic good's provider (e.g., software provider).

The content of this disclosure will often be explained in regard to software registration for computers, however it will be appreciated that the techniques and systems provided herein can be applied to a wide range of applications. For example, any electronic good provided in digital form (e.g., music, video, books) may utilize a method of registration set forth in this disclosure. Similarly, the method may be performed for electronic goods installed on any electronic device, such as PDAs, cell phones, etc. Furthermore, the trusted verifier (e.g., phone registration server) is denoted in figures as a separate element from the software provider. However, it will be appreciated that the trusted is often owned by the software provider and the separate elements could also be represented as a single element.

For digital signatures asymmetric cryptography uses a pair of cryptographic keys, a private key and a public key. A sender's private key is usually kept secret by a sender and is not distributed to other parties. A sender's public key is usually widely distributed. In digital signatures a hash value of a plaintext input is signed with a sender's private key to form a unique digital signature that can only be formed using the sender's public key. Therefore, by keeping his private key private the sender ensures that he cannot be impersonated by malicious third parties. The digital signature is sent with the message and to a receiver (e.g., anyone who has access to the senders public key) who can use the sender's public key to verified the digital signature upon receipt. By verifying the digital signature the receiver ensures the authenticity of data (e.g., email, software, etc.) received from a sender.

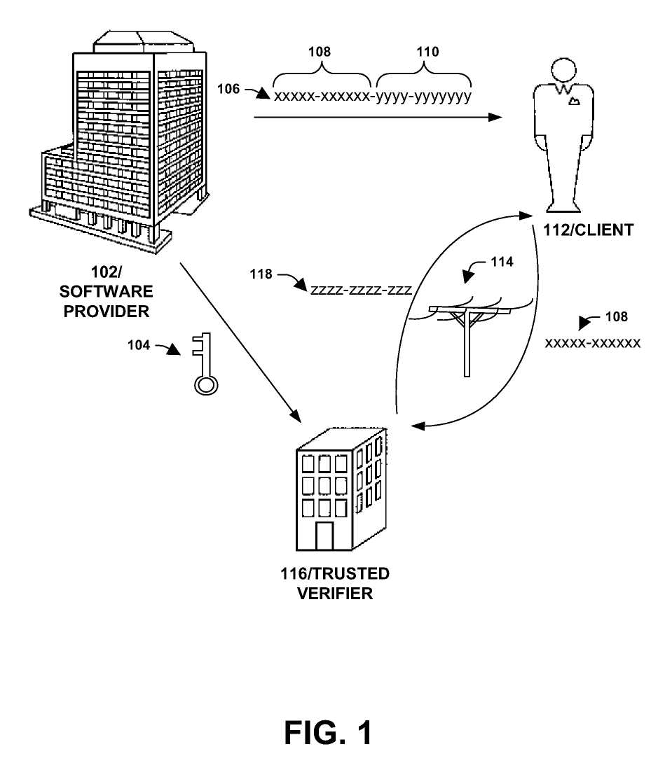

FIG. 1 shows a block diagram of a method for software registration via a telephone using a reduced length product ID. A software provider 102 provides a product ID 106 to a client 112 purchasing software. The product ID 106 comprises a message 108 and a digital signature 110, wherein the digital signature 110 is a hash value of the message 108 encrypted with the software provider's private key 104. The client 112 performs a verification via a telephone network 114 to ensure that the client 112 is not using a pirated (e.g., unauthorized copy of a copyrighted software program) version of the software. The verification requires that the client 112 provide the digital signature portion (e.g., 110) of the product ID to a trusted verifier 116 (e.g., a registration server trusted to have the software provider's private key) that has the software provider's private key 104. The trusted verifier 116 uses the software provider's private key 104 to ensure that the client 112 is not using a pirated (e.g., unauthorized copy of a copyrighted software program) version of the software. If the expected structure is found, the electronic good is authentic and the trusted verifier 116 then returns a registration code 118 to the client which activates the client's software.

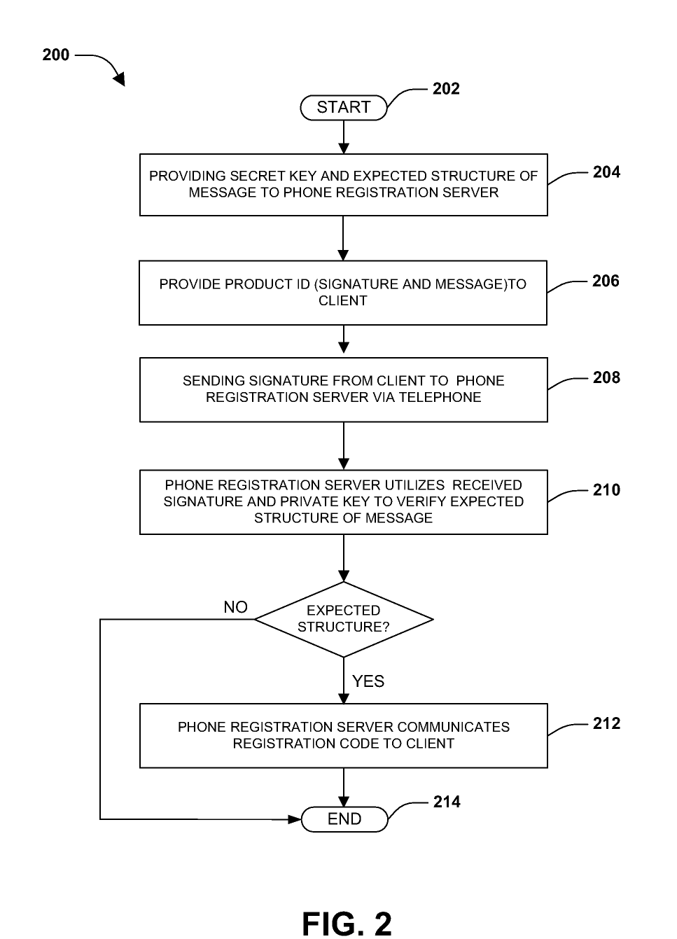

FIG. 2 shows a flow chart illustrating an exemplary method 200 for utilizing a bi-linear pairing signature system to facilitate telephone registration of software. More particularly, the method 200 allows a shortened portion of the product ID code (e.g., the digital signature) to be communicated by a client over the telephone to a trusted verifier (e.g., a registration server trusted to have the software provider's private key). The trusted verifier (e.g., telephone registration server) has the software provider's private key which it uses along with the shortened portion of the product ID code (e.g., the digital signature) to reconstruct the message. If the message has an expected structure, the validity of the product ID is authentic and the trusted verifier (e.g., telephone registration server) returns a registration code to the client, which the client enters into their electronic device (e.g., computer) thereby allowing the software to function properly.

At 204 a private key is provided by the software provider to a trusted verifier (e.g., a telephone registration server). The software provider's private key is used by the software provider to sign its digital signature. Often the software provider owns the trusted verifier (e.g., telephone registration server, but in cases where the software provider and trusted verifier are separate entities, the software provider's private key can be delivered to the trusted verifier (e.g., telephone registration server) by a number of methods. For example, a trusted courier could be used to deliver the private key to the trusted verifier. A cheaper alternative would be to break the private key into multiple (e.g., three) pieces and to deliver respective pieces in a separate channel (e.g., email, telephone, physical mail, etc.).

The product ID, comprising the message and the digital signature, is communicated from the software provider to the client at 206. A product ID is a string of alpha numeric characters. Traditionally, a client communicates the entire product ID to a verifier (e.g., untrusted) who confirms that the product ID is authentic (e.g., unmodified) thereby ensuring that the user receives an un-tampered, un-pirated product. For example, the client may provide the product ID to the software provider who confirms that the software is authentic (e.g., not from a source other than the software provider and not tampered with) and not pirated (e.g., being used without authorization).

The product ID can be communicated from the software provider to the client in various ways depending on the method of purchase. For example, store bought software comprising a fixed computer readable media (e.g., CD-ROM) may have a product ID code printed on the media or included in the software package (e.g., box). Software downloaded over a network (e.g., Internet) may provide a product ID number on screen at the time of purchase or over email.

At 208 the digital signature portion of the product ID is communicated from the client, via a telephone, to a trusted verifier (e.g., telephone registration server). The digital signature portion of the product ID is a subset of the entire product ID traditionally communicated for product registration. For example, if the product ID contains 25 alpha numeric characters the digital signature portion may comprise the first 10 characters of the product ID. In one example, the digital signature length is substantially equal to half that of a digital signature algorithm (DSA) signature for a substantially equal strength encryption.

At 210 the trusted verifier (e.g., telephone registration server) utilizes the received digital signature and the software provider's private key to verify that the digital signature is authentic (e.g., signed by the software provider). The trusted verifier uses the private key and the digital signature to reconstruct the message and then looks for a predetermined expected structure in the message. If the expected structure is present in the recovered message then the received digital signature is authentic. If the expected structure is not present in the recovered message than the received digital signature is not authentic.

If the received digital signature is authentic, the telephone registration server communicates a registration code to the client at 212. The registration code can be entered into the client's electronic device (e.g., computer) to allow the software to be fully operational. If the received digital signature is not authentic, the telephone registration server does not communicate a registration code to the client and the software cannot be utilized.

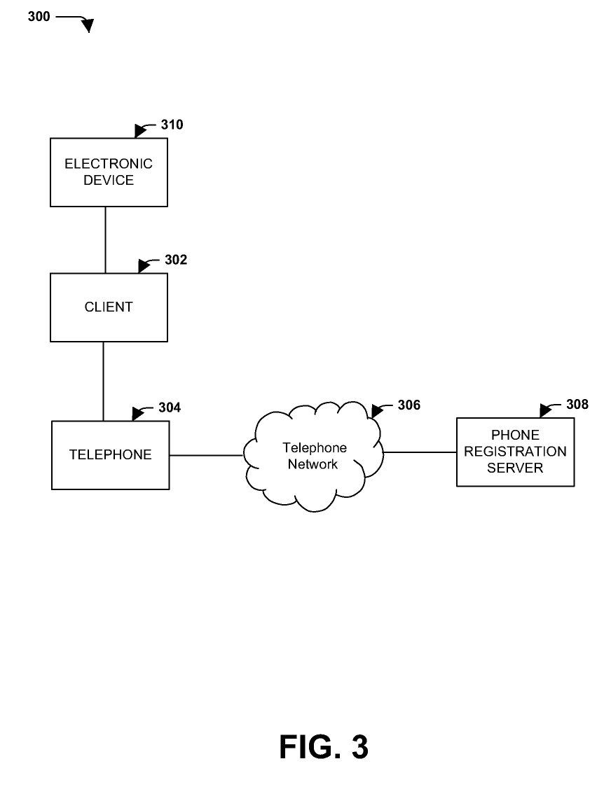

FIG. 3 illustrates a system configured to perform a first software verification (e.g., by an un-trusted verifier) and a second software verification method (e.g., by a trusted verifier) as provided herein. The client 302 has access to an electronic device 310 (e.g., computer, PDA) and a telephone 304. The electronic device 310 (e.g., computer) can act as the un-trusted verifier (e.g., a registration server not trusted to have the software provider's private key) and perform a first verification method. The client 302 performs the first verification by inputting the entire product ID (e.g., message and the digital signature) into the electronic device 310 which utilizes the message and digital signature in conjunction with a first and second public key from the software provider to validate the authenticity of the product ID code thereby ensuring that the software is authentic. The client 302 can also connect to the telephone registration server 308 via the telephone 304 and telephone network 306 to perform the second verification. To perform the second verification the client 302 inputs (e.g., speaks or enters via the touchtone keypad) the digital signature portion of the product ID (e.g., the first 10 characters of a 25 character product ID) in the telephone 304. The telephone 304 communicates the digital signature portion of the product ID over the telephone network 306 to the telephone registration server 308 (e.g., trusted verifier) which uses the digital signature and the software provider's private key to validate the authenticity of the product ID thereby once again ensuring that the software is not pirated. If the product ID code is verified the telephone registration server 308 (e.g., trusted verifier) communicates a registration code over the telephone network 306 to the client 302 who enters the registration code into the electronic device 310 running the software thereby allowing the software to function properly.

In one example, the telephone registration server of FIG. 3 utilizes a secret sharing scheme to increase the key management security of the system (further explained below). In such an example, the telephone registration server is comprised of a plurality of individual servers. The software provider's private key is segmented into a plurality of separate shares (e.g., pieces), respective shares of the software provider's private key being stored in respective servers. Segmenting the software provider's private key among a plurality of servers and allocating a share of the private key to respective servers provides enhanced security since the private key can only be reconstructed when all of the individual shares of the private key are combined. For example, assuming the software provider's private key is segmented into three shares stored on three servers comprising the telephone registration server and assuming one server (e.g., one share of the private key) is compromised, the intruder still will not have the software provider's entire private key (however, neither will the telephone registration server).

In a further example, the telephone registration server of FIG. 3 utilizes a secret sharing scheme with a threshold (further explained below). The secret sharing scheme with a threshold provides a robust system of key management. It is similar to the secret sharing scheme, except it allows the private key can be recovered even if a minority of the servers are compromised (e.g., destroyed, breached), yet breaching parties cannot reconstruct the key even when a security breaches expose a minority of the shares.

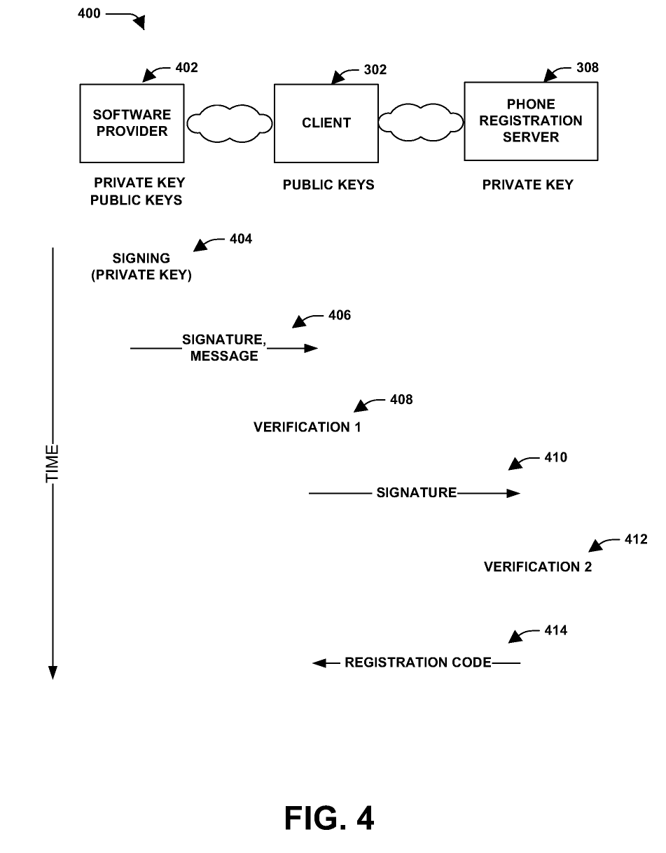

FIG. 4. illustrates a communication diagram showing the transfer of data wherein a first (e.g., untrusted) and a second (trusted) verification are performed, where the passage of time is denoted from the top to the bottom of the figure.

As shown in FIG. 4, the software provider 402 is in possession of his own private key, and two public keys. The client 302 is in possession of the software provider's two public key(s). The two public key(s) could be provided as part of the software package in one application or could be obtained via the Internet (e.g., from a webpage) in another. The telephone registration server 308 (e.g., trusted verifier) is in possession of the software provider's private key and the one or more public key(s).

In FIG. 4, the communication diagram 400 starts with a software provider 402 using its private key to sign its digital signature 404 (e.g., a hashed message signed with its private key). Once the digital signature is signed the software provider 402 will send the digital signature and the message 406 (e.g., the product ID) to the client 302. Usually this transfer is performed at the time of the sale of the electronic good (e.g., software package), by providing the client with the product ID during the purchase.

The client 302 performs a first verification 408 using the software provider's two public keys, the digital signature, and the message to verify that the message and digital signature are authentic (e.g., an unmodified version of the software from the software provider). The first verification 408 requires the client enter the entire product ID (e.g., the message and the digital signature) into his electronic device which already has the software provider's two public keys.

Once the first verification is complete, the client communicates (e.g., speaks or enters via the touchtone keypad) the digital signature 410 to the telephone registration server 308 (e.g., trusted verifier owned by the software provider). The telephone registration server 308 performs a second verification 412 using the digital signature and the software providers private key to ensure that the client is not using a pirated (e.g., unauthorized copy of a copyrighted software program) version of the software. The telephone registration server 308 then sends a registration code 414 to the client 302. The client 302 can enter the registration code into his electronic device to allow the digital good to be fully operational.

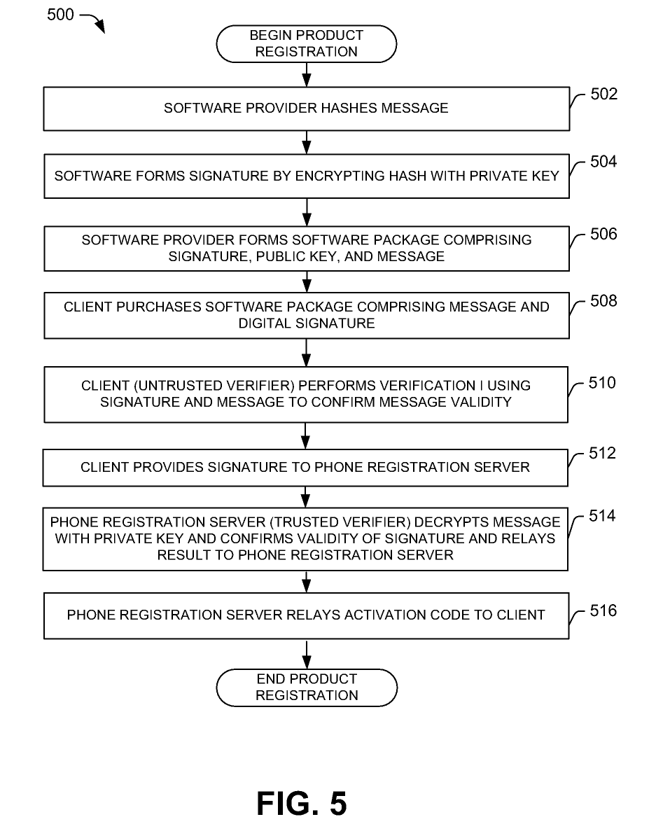

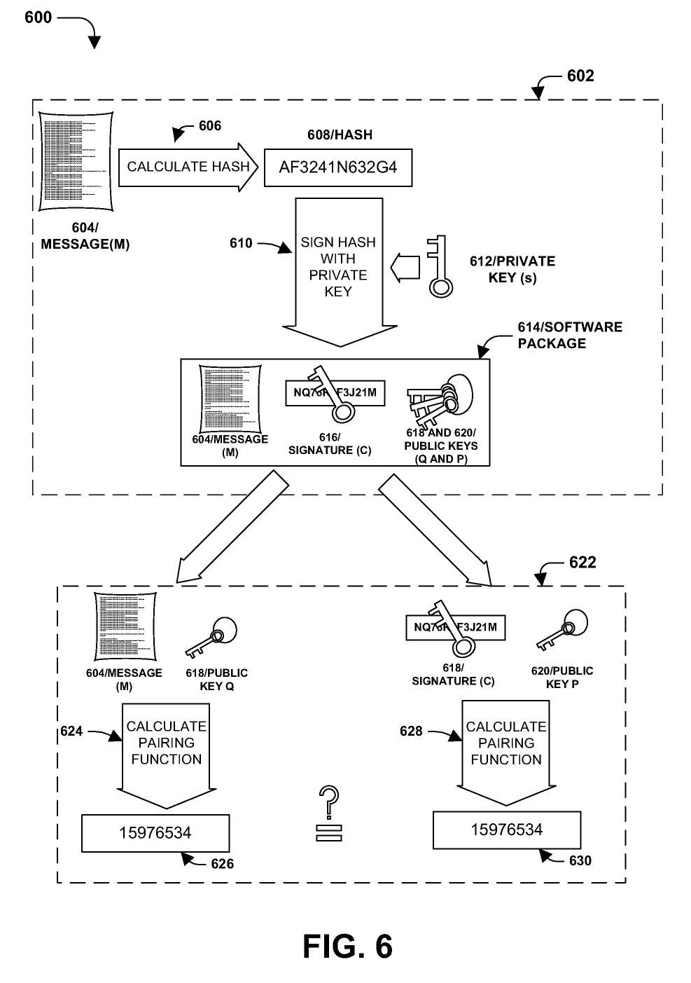

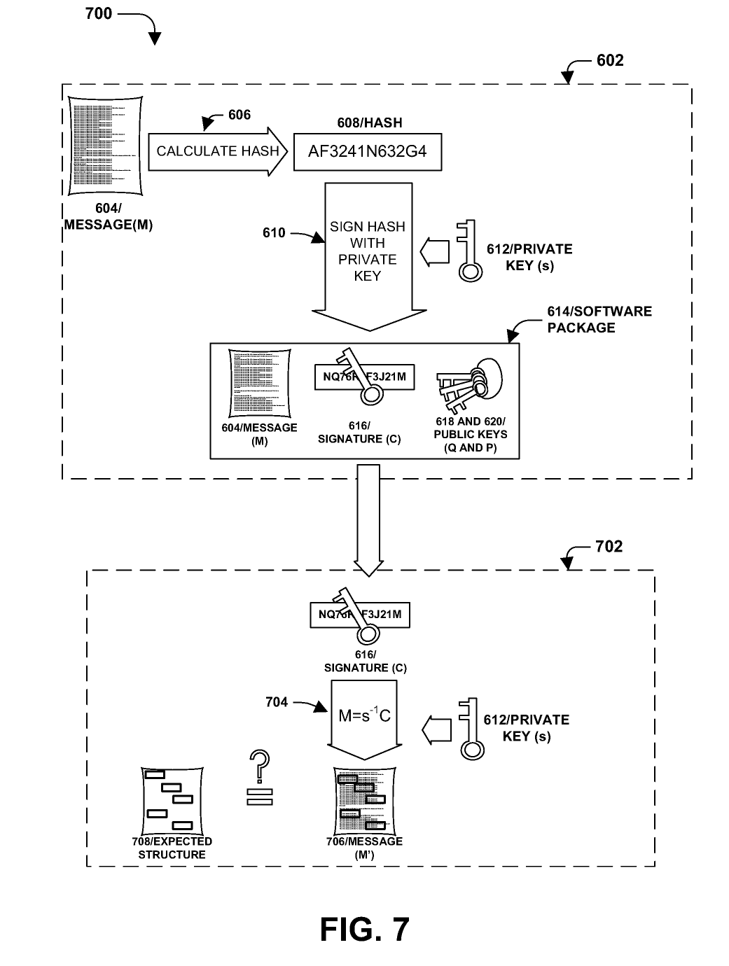

FIG. 5 is a flow chart illustrating a detailed exemplary method 500 of product registration according to one example. FIGS. 6 and 7 provide further details of the process. More particularly, the method 500 performs a first (untrusted) and a second (trusted) verification to ensure that the software is authentic and not pirated. In the first verification, an untrusted verifier (e.g., client computer) utilizes the product ID (e.g., message and digital signature) and two public keys (e.g., a first public key Q and a second public key P) to perform a bi-linear pairing verification. In the second verification, a trusted verifier utilizes the digital signature portion of the product ID and the software provider's private key to perform a bi-linear pairing verification. If both verifications return positive results (e.g., the software is authentic) then the registration is complete.

At 502 the software provider 602 hashes the message (M) 604. Hashing 606 is performed by applying a hashing function (e.ga hashing function that hashes to points on an Elliptic Curve) to the message (M) 604 which returns a relatively small string of characters called the hash value 608. The hash value 608 is a short a summary of the original messages (M) 604 computed with a hashing function. A hash value 608 is nearly impossible to derive the original input number without knowing the data used to create the hash.

The hash value 608 is signed 610 using the software provider's private key (s) 612 forming a digital signature (C) 618 at 504. The digital signature (C) 618 (e.g., signed hash value) provides a way to ensure that the message (M) 604 is authentic (e.g., not altered in any way since it was created by the software provider).

At 506 the software provider 602 forms a software package 614 comprising a product ID comprising the digital signature (C) 616 and the message (M) 604. The software provider's public key(s) (Q and P) 618 and 620 (where P is proportionate to Q and the private key s. (e.g., P=sQ)), may optionally be provided as part of the software package 614 in one embodiment. In other embodiments the public keys Q and P, 618 and 620, may be obtained via other means (e.g., downloaded from the Internet ).

At 508 the client (not shown in FIG. 6 or 7) obtains the software package 614 comprising the message (M) 604 and digital signature (C) 616. The client may for example purchase the software package 614 from the software provider 602 or a third party vendor.

The client performs verification I 600 using the digital signature (C) 616 and message (M) 604 to confirm the software's authenticity at 510. The message (M) 604 and the digital signature (C) 604 are communicated to an untrusted verifier 622 (e.g., clients computer) who has the software provider's two public keys (Q and P) 618 and 620. The untrusted verifier 622 (e.g., client's computer) calculates a pairing function p(x,y) (e.g., a function which uniquely maps two non-negative integers into a single non negative integer) which takes two numbers (e.g., message (M) and public key (Q)) and (e.g., message and public key) and manipulates them to get a third number. For example, to perform the first verification a first pairing function may be calculated 624 from the message (M) 604 and the public key Q 618 which results in a first number Y626 (e.g., Y=p(M,Q)). Similarly, a second pairing function (e.g., can be substantially equal to the first pairing function) may be calculated 624 from the digital signature (C) and public key P 620 which results in a second number X 630 (e.g., X=p(C,P)) If the first number Y 626 and the second number X 630 and are equal (e.g., p(C,F)=p(M,Q)) it signifies that the message (M) 604 and digital signature (C) 616 are authentic (e.g., software has not been altered in any way since it was created by the software provider) and verification I is complete.

At 512 the client provides the digital signature (C) 616 portion of the product ID to a trusted verifier 702 (e.g., telephone registration server). The client can provide the digital signature (C) 616 to the telephone registration server 702 by either speaking the digital signature (C) 616 or entering the digital signature (C) 616 using a touchtone keypad via a telephone.

The telephone registration server 702 performs verification II 700 using the digital signature (C) 616 and software provider's private key (s) 612 to confirm the software's authenticity at 514. The telephone registration server 702 uses the software provider's private key (s) 612 to attain the message (M) 604. For example, the message (M) 604 can be recovered from the digital signature (C) 616 by multiplying (e.g., modular multiplication) the inverse of the private key (s) 612 and the digital signature (C) 616:

M=s⁻¹C

Once the recovered message (M′) 706 is obtained the telephone registration server 702 looks for an expected structure 708 (e.g., runs of zeroes in expected places, zeroes in particular places, etc.) in the recovered message (M) 706. If the expected structure is found, then the telephone registration server 702 knows that the recovered message (M′) 706 is authentic. If the expected structure is not found, then the telephone registration server 702 knows that the recovered message (M′) 706 is not authentic.

If the expected structure is found the telephone registration server 702 relays an authentication code to the client at 616. The client can enter the registration code into their electronic device to allow the digital good to be fully operational or the digital content to be fully accessed.

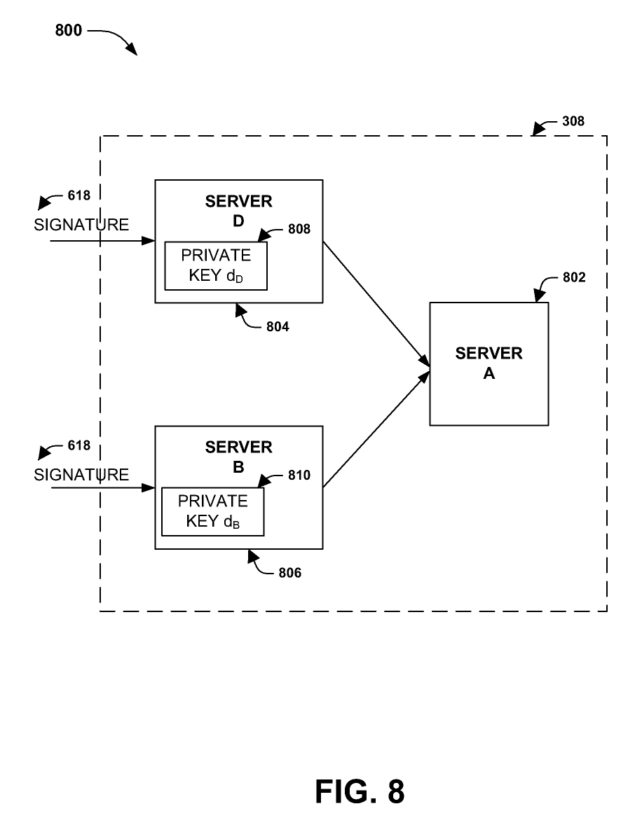

FIG. 8 sets forth a more detailed example of a registration server utilizing a simple secret sharing scheme between three different servers collectively comprising the telephone registration server. The secret sharing scheme segments the software provider's private key into a plurality of shares, respective shares stored in independent servers. The entire plurality of shares must be recovered to recover the entire private key, therefore preventing partial breaches (e.g., breaches of less than all the independent servers) from compromising the private key. The telephone registration server 308 may comprise of a plurality of independent servers: server A 802, server B 806, and server D 804. Shares of a private key are segmented between server B 806 and server D. Server A 802 has no share of the private key. To be verifiable, auxiliary information can be provided to servers B and D, 806 and 804, that allows them to verify their shares as consistent. To perform a complete recovery of a message the shares of the private key from server B 806 and server D 804 must both be used. For example, if s is the private key, respective servers B and D will have shares of the private key d_{B} 808 and d_{D} 810 such that d_{B}+d_{D}=s⁻¹ mod q, where q is the group order and is equal to a prime number. Both server B 806 and server D 804 perform a partial message recovery by applying their respective shares of the private key to the received digital signature (C) 618. The results the message recovery performed by server B and server D are communicated to server A which subsequently performs full recovery of the message:

M=d_{B}C+d_{D}C

Utilization of verifier secret sharing tolerates the compromise of any one server without compromising the entire system.

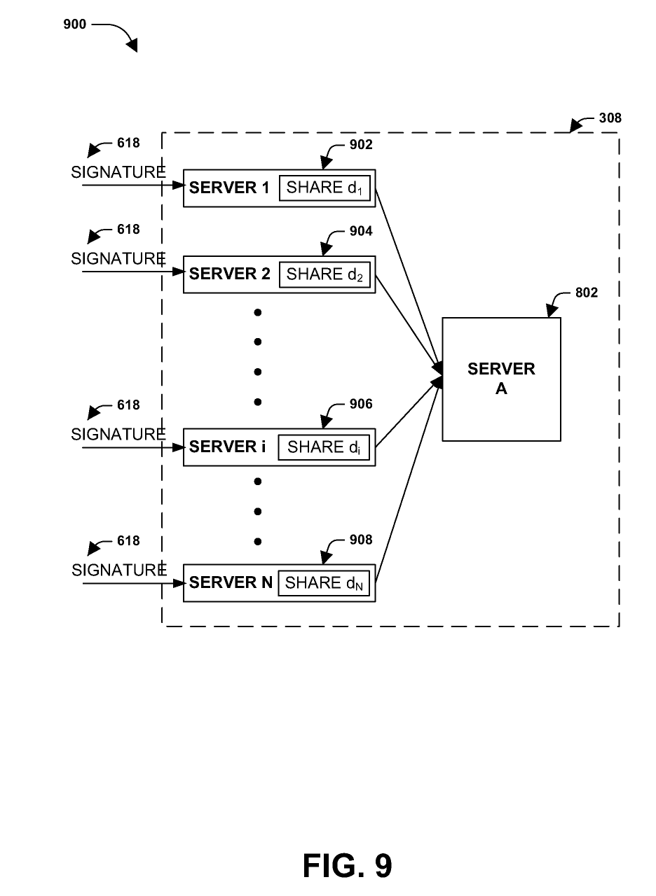

FIG. 9 sets forth a more detailed example of a registration server utilizing a simple secret sharing with a threshold scheme. The telephone registration server 308 is comprised of a plurality of independent servers: server A 802, and servers 1 to N. N shares of a private key (s) are segmented between servers 1 902 to server N 908. Respective servers receive a share of the private key (s), such that any subset k of the N servers can recover the private key (s). If an adversary takes over any number of servers less than N−k, functionality and security of the telephone registration server is not effected. In one particular example, a (n,k) threshold scheme divides the private key (s) among n players, such that any subset of k of them can recover the secret. Assuming n<2k, if the adversary takes over any ≦n−k servers, functionality and security are not affected. For example: Let p(x) be a secret polynomial of degree k−1 over Z_{q}. The signature is C=p(0)⁻¹M, and so M=p(0)C. Server i gets share si=p(i), i=1,2, . . . n. So, any subset of k servers can find the polynomial and compute M from C. More precisely, server A, which is not privy to any secret, will get from server i value p(i)C.

Comparison of standard secret sharing to the modified version further illustrates the operation of the approach. Standard secret sharing works by letting r,s denote the k-vectors of values of the above secret polynomial, and its coefficients, respectively. There is a known k-by-k Vandermonde matrix V, such that r=Vs mod q. So, given r, s=V⁻¹r mod q can be found, which includes p(0). In the modified version used herein, rC is known instead of r where C is not integer, but an element of G1 (e.g., a point on an elliptic curve). However, it is still true that rC=(Vs)C in G1, and therefore that sC=V⁻¹rC, which includes M=p(0)C.

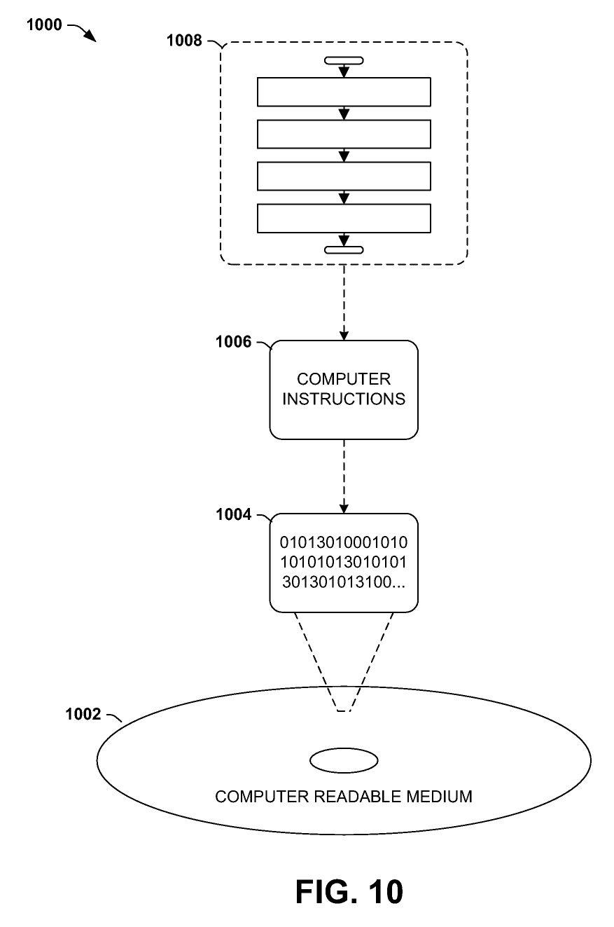

Still another embodiment involves a computer-readable medium comprising processor-executable instructions configured to apply one or more of the techniques presented herein. An exemplary computer-readable medium that may be devised in these ways is illustrated in FIG. 10, wherein the implementation 1000 comprises a computer-readable medium 1002 (e.g., a CD-R, DVD-R, or a platter of a hard disk drive), on which is encoded computer-readable data 1004. This computer-readable data 1004 in turn comprises a set of computer instructions 1006 configured to operate according to one or more of the principles set forth herein. In one such embodiment, the processor-executable instructions 1006 may be configured to perform a method of 1008, such as the exemplary method 200 of FIG. 2, for example. In another such embodiment, the processor-executable instructions 1006 may be configured to implement a system configured to improve the relevance rank of web searches for a query. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

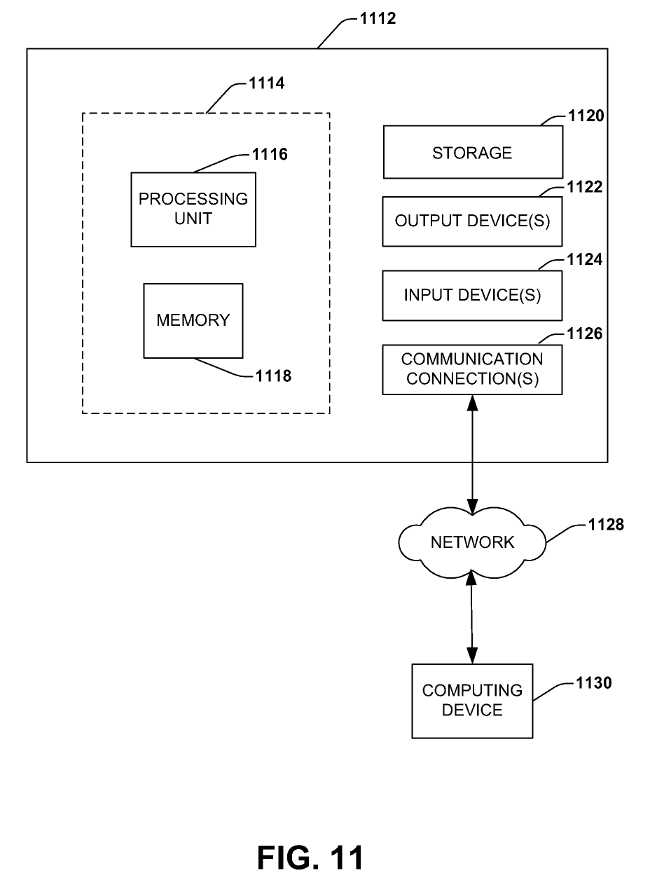

FIG. 11 and the following discussion provide a brief, general description of a suitable computing environment to implement embodiments of one or more of the provisions set forth herein. The operating environment of FIG. 11 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 11 illustrates an example of a system 1110 comprising a computing device 1112 configured to implement one or more embodiments provided herein. In one configuration, computing device 1112 includes at least one processing unit 1116 and memory 1118. Depending on the exact configuration and type of computing device, memory 1118 may be volatile (such as RAM, for example), non-volatile (such as ROM, flash memory, etc., for example) or some combination of the two. This configuration is illustrated in FIG. 11 by dashed line 1114.

In other embodiments, device 1112 may include additional features and/or functionality. For example, device 1112 may also include additional storage (e.g., removable and/or non-removable) including, but not limited to, magnetic storage, optical storage, and the like. Such additional storage is illustrated in FIG. 11 by storage 1120. In one embodiment, computer readable instructions to implement one or more embodiments provided herein may be in storage 1120. Storage 1120 may also store other computer readable instructions to implement an operating system, an application program, and the like. Computer readable instructions may be loaded in memory 1118 for execution by processing unit 1116, for example.

The term “computer readable media” as used herein includes computer storage media. Computer storage media includes volatile and nonvolatile, removable and non-removable media implemented in any method or technology for storage of information such as computer readable instructions or other data. Memory 1118 and storage 1120 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 1112. Any such computer storage media may be part of device 1112.

Device 1112 may also include communication connection(s) 1126 that allows device 1112 to communicate with other devices. Communication connection(s) 1126 may include, but is not limited to, a modem, a Network Interface Card (NIC), an integrated network interface, a radio frequency transmitter/receiver, an infrared port, a USB connection, or other interfaces for connecting computing device 1112 to other computing devices. Communication connection(s) 1126 may include a wired connection or a wireless connection. Communication connection(s) 1126 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 1112 may include input device(s) 1124 such as keyboard, mouse, pen, voice input device, touch input device, infrared cameras, video input devices, and/or any other input device. Output device(s) 1122 such as one or more displays, speakers, printers, and/or any other output device may also be included in device 1112. Input device(s) 1124 and output device(s) 1122 may be connected to device 1112 via a wired connection, wireless connection, or any combination thereof. In one embodiment, an input device or an output device from another computing device may be used as input device(s) 1124 or output device(s) 1122 for computing device 1112.

Components of computing device 1112 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 1112 may be interconnected by a network. For example, memory 1118 may be comprised of multiple physical memory units located in different physical locations interconnected by a network.

Those skilled in the art will realize that storage devices utilized to store computer readable instructions may be distributed across a network. For example, a computing device 1130 accessible via network 1128 may store computer readable instructions to implement one or more embodiments provided herein. Computing device 1112 may access computing device 1130 and download a part or all of the computer readable instructions for execution. Alternatively, computing device 1112 may download pieces of the computer readable instructions, as needed, or some instructions may be executed at computing device 1112 and some at computing device 1130.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Furthermore, it will be appreciated that the message referred to is a hash value of a plaintext message. While beyond the scope of this application, those experienced in the art will appreciate that the message hash value is not an ordinary hash value used with RSA, but is a hash to point value computed based upon an elliptical curve according to the bi-linear pairing system method.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes” , “having”, “has”, “with”, or variants thereof are used in either the detailed description or the claims, such terms are intended to be inclusive in a manner similar to the term “comprising.”

What is claimed is:

1. A method for verification of a digital good, comprising:
providing a product identification code (product ID) to a client, the product ID comprises a message and a digital signature signed with a digital good provider's private key;
providing the digital good provider's private key to a trusted verifier;
receiving the digital signature from the client to the trusted verifier by a telephone;
reconstructing the message from the digital good provider's private key and the digital signature;
examining the message for an expected structure; and
communicating a registration code from the trusted verifier to the client if the expected structure is present.

2. The method of claim 1, reconstructing the message comprising multiplying the digital signature by the digital good provider's private key.

3. The method of claim 2, comprising inputting the registration code into an electronic device to provide full operation of the digital good.

4. The method of claim 3, the trusted verifier segmenting the digital good provider's private key into a plurality of shares and storing respective shares in a plurality of independent servers.

5. The method of claim 4, respective independent servers reconstructing respective shares of the message and communicating their respective shares of the message to one of the plurality of independent servers which performs a recovery of the message.

6. The method of claim 5, respective shares of the message from the entire plurality of independent servers are required to reconstruct the message.

7. The method of claim 5, respective shares of the message from a majority of the independent servers are required to reconstruct the message.

8. The method of claim 7, communicating the digital signature from the client to the trusted verifier comprising entering the digital signature on a touchtone keypad of the telephone.

9. The method of claim 5, the expected structure comprising zeroes in certain locations of the message.

10. The method of claim 5, comprising a verification option that comprises communicating the digital signature and the message to an un-trusted verifier who has a digital good provider's first public key and a digital good provider's second public key.

11. The method of claim 10, an untrusted verifier performing a verification comprising:
using a pairing function to map the digital good provider's first public key and the message to a first number;
using the pairing function to map the digital good provider's second public key and the digital signature to a second number; and
comparing the first and the second number and verifying the digital good's authenticity if the first number and the second number are equal.

12. A system configured to verify product keys, comprising:
a telephone registration server comprising a software provider's private key configured to receive a product ID code comprising a digital signature and a message from a client; and
a trusted verifier configured to receive the digital signature portion of the product ID from the client via a telephone and verify the authenticity of the digital signature according to a bi-linear pairing signature system.

13. The system of claim 12, the trusted verifier configured to verify the authenticity of the digital signature by reconstructing the message from the software provider's private key and the digital signature and examining the message for an expected structure.

14. The system of claim 13, the trusted verifier configured to communicate a registration code from the trusted verifier to the client if the expected structure is present.

15. The system of claim 14, the trusted verifier comprising a plurality of independent servers, respective independent servers configured to store respective shares of the software provider's private key and reconstruct respective shares of the message.

16. The system of claim 15, respective shares of the message from the entire plurality of independent servers are required to reconstruct the message.

17. The system of claim 15, respective shares of the message from a majority of the plurality of independent servers are required to reconstruct the message.

18. The system of claim 15, comprising an un-trusted verifier, the un-trusted verifier configured to:
receive the digital signature, the message, a first public key, and a second public key from the client;
calculate a pairing function that maps the first public key and the message to a first number;
calculate the pairing function that maps the second public key and the digital signature to a second number; and
compare the first and the second number and verifying the software's authenticity if the first number and the second number are equal.

19. The system of claim 15, the length of the digital signature is substantially equal to half that of a digital signature algorithm (DSA) signature for a substantially equal strength encryption.

20. A method for verification of a software, comprising:
providing a product ID to a client, the product ID comprises a message and a digital signature signed with a software provider's private key;
providing the software provider's private key to a trusted verifier, the trusted verifier segmenting the software provider's private key into a plurality of shares and storing respective shares in an independent server;
receiving the digital signature from the client to the trusted verifier by a telephone;
reconstructing the message from the software provider's private key and the digital signature by multiplying the digital signature by the software provider's private key;
examining the message for an expected structure comprising zeroes located in certain locations of the reconstructed message;
communicating a registration code from the trusted verifier to the client if the expected structure is present; and
inputting the registration code into an electronic device to provide full operation of the software.
